(19) United States
(12) Patent Application Publication
(10) Pub. No.: US 2025/0272157 A1
(43) Pub. Date: Aug. 28, 2025

(54) Programmatic Work Assignment For Dynamically Load-Balanced Persistent Execution

(71) Applicant: NVIDIA Corporation, Santa Clara, CA (US)

(72) Inventors: Apoorv PARLE, Santa Clara, CA (US); Gentaro HIROTA, San Jose, CA (US); Ronny M. KRASHINSKY, Portola Valley, CA (US); Manan PATEL, San Jose, CA (US); Rajballav DASH, San Jose, CA (US); Shayani DEB, Seattle, WA (US); David Rigel GARCIA GARCIA, North York (CA); Luke DURANT, San Jose, CA (US)

(21) Appl. No.: 18/590,479

(22) Filed: Feb. 28, 2024

(51) Int. Cl. G06F 9/50

(52) U.S. Cl. CPC G06F 9/5055; G06F 9/5038; G06F 9/505

(57) ABSTRACT

In a GPU design, “launching a worker” is de-coupled from “assigning a work item” in a work distributor, and new handshake mechanisms between a worker and the work-distributor is provided for work assignment, in order to provide persistent kernel functionality. In example embodiments, software specifies the work that has to be done, hardware selects a variable number of workers based on available resources, and a hardware scheduler handshaking with the executing workers assigns more work as previously assigned work is completed and/or more resources become available.

### CROSS-REFERENCE TO RELATED APPLICATIONS

### FIELD

This technology relates to distributing work to processing cores, and more particularly to distributing work to persistently executing entities to minimize latency associated with initialization. Still more particularly, the technology herein relates to a graphics processing unit (GPU) that enables execution that is already running on processing cores to request and receive multiple, new and/or additional work assignments without incurring overhead to reinitialize execution. The technology also relates to mechanisms by which executing entities can provide feedback to work distributors or schedulers to enable dynamic load balancing of work performed across many concurrent processing cores.

### BACKGROUND

As technology progresses and size of chips grow, it is desirable for applications to scale to an increasing number of compute cores. As we try to strong-scale, the amount of work assigned to each compute core becomes smaller and is completed more quickly. These trends pose new challenges, for example:
1) The completion signal and subsequent launch signal travel longer physical distances on the chip(s), resulting in longer delays while compute cores are idle.
2) A single work-item no longer provides sufficient parallelism to saturate the compute core throughput. This is especially true when a work-item contains multiple phases of work, for example, a multi-stage pipeline.
3) As computation time gets shorter, the overhead of initializing hardware and software state to do actual work, and then tearing it all down at end of a work-item, becomes significant. This limits overall throughput constrained by Amdahl's law.

For example, in a highly parallel system such as a graphics processing unit (GPU) comprising many computation cores, the total work is typically represented in the form of a large set of work, and a work distribution mechanism launches the work piece-by-piece to each compute core, with the goal of maximizing occupancy across the whole system. Current GPUs have hundreds or thousands of cores each of which execute many threads organized as thread blocks. In one implementation, NVIDIA's CUDA system typically represents this parallel work as a grid of thread blocks (sometimes called a “CTA” or “cooperation thread array”), where a thread block comprises many threads and a grid is a multidimensional arrangement of such thread blocks. See e.g., US20230289215-A1; docs.nvidia.com/cuda/cuda-c-programming-guide/index.html

### an Example of how Work May be Assigned in Such an Arrangement

A thread is typically assigned a unique identifier which also corresponds to a work item. A thread block, which is a collection of threads, may for example be identified by a unique identifier “threadblock index” derived from any of its threads. When programs execute the compute work, the kernel code looks up the thread block index to identify what specific work item(s) should be computed. To take an illustrative example, suppose the compute work is the simple addition of two large tensors (e.g., 1 GB each). A different thread block can be assigned to perform calculations for each part or cell of the tensors. In one example, there may be 1024 thread blocks per row and 1024 thread blocks per column of the tensor, for a total of 1024²=1,048,576 thread blocks (each thread block containing many threads). As one example, it is possible to launch a grid of 1,048,576 thread blocks by one dimension.

In this example, each thread block in the grid is going to look up its thread block index, load the corresponding data from the memory, do the addition, and write out the result. Each thread block thus uses its thread block index to realize what slice of the problem statement (work item) the thread block is going to perform.

A GPU work distributor mechanism (typically a hardware-implemented circuit or a software-controlled function block or a combination of hardware and software that may be called “WD” or “CWD” for “compute work distributor”) receives a work description in the form of work grid dimensions and “rasterizes” the grid by launching a thread block onto each processing core. For example, if there are 100 available processing cores to perform the compute work, a compute work distributor circuit (“CWD”) can launch 100 thread blocks (one for each available core) to fill up the cores with thread blocks to execute. Each thread block will execute code, load up its thread block index, and perform the associated calculations. Once the thread block is done with all its calculations and completes, the thread block will reach its endpoint and exit. When that exit operation happens, a thread block completion signal is sent to CWD. When the completion signal reaches CWD, CWD recognizes that the core that executed the thread block is now free and can launch a next thread block onto that core to perform a different work item. This process happens over and over until all 1,048,576 thread blocks have been launched, execute, and complete.

### BRIEF DESCRIPTION OF THE DRAWINGS

FIG. 1 shows an example regular grid of CTAs.

FIG. 2 shows an example persistent kernel.

FIG. 3 shows an example persistent kernel with static scheduling.

FIG. 4 shows an example persistent kernel with dynamic scheduling.

FIG. 5 shows an example persistent kernel with hybrid scheduling.

FIG. 6 shows an example hardware persistent kernel.

FIG. 7A shows an example where the kernel is both the worker and the work.

FIG. 7B shows an example where the kernel is the worker and a work distributer dynamically assigns the work to the worker.

FIG. 7C shows existing inter-thread synchronization of a work item request by a processing core.

FIG. 8 shows a workid XYZ Example.

FIG. 9 shows an example work item Response layout in shared memory.

FIG. 10 shows an example flow of a work item request and responses.

FIG. 10A shows an overall flowchart of example handling of a work item request.

FIG. 11A shows example messages between a processing core and an M-Pipe controller (“MPC”) circuit.

FIG. 11B shows example Messages between a GPM synchronization processor circuit.

FIG. 12 shows example messages Between a GPM and a CWD.

FIG. 13 shows Example operations performed by CWD upon Receipt of a workid_req packet originated from a core.

FIG. 14 shows Example Operations a Core Performs Upon Receiving a work item response originated by a CWD.

FIG. 15A shows example MPC operations on receiving a workid_req packet from a core.

FIG. 15B shows example Operations an MPC performs on receiving a workid_response packet from GPM.

FIG. 16 shows example GPM Functionality.

FIG. 17A shows example GPM operations on receiving a workid_request packet from an MPC.

FIG. 17B shows example GPM operations on receiving a workid_response packet from CWD.

FIG. 17C shows example GPM operations on receiving a broadcast ack packet from processing cores.

FIG. 18A shows a GPU architecture focusing on a block diagram of a task/work unit including a scheduler and a load-balancing Compute Work Distributor, interacting with processing cores.

FIG. 18B shows a hierarchical compute work distributor including functional blocks used to distribute work to processing cores (SMs) within different hardware partition levels.

FIGS. 19 and 20 show example non-limiting flowcharts of hardware-implemented operational steps for launching work to processing cores.

### DETAILED DESCRIPTION OF NON-LIMITING EMBODIMENTS

Strong Scaling is Desirable but there are Obstacles

As noted above, GPU cores are getting faster, more efficient and more numerous. This means the amount of time each such thread block as described above is actually running is decreasing. One would hope that increasing the number of and the speed of the cores should linearly scale to the amount of compute work the GPU can perform, but this does not necessarily happen in practice. For example, increasing the number of cores on a GPU means the physical distance between CWD and each core is increasing. The longer communication path lengths increase the time it takes for work assignment communication overhead—namely for CWD to (a) send a work assignment (i.e., a first thread block) to the core and have the core start executing the work assignment; (b) receive a completion signal indicating the core has completed executing the work assignment; and (c) send an additional work assignment (e.g., a different, second thread block) to the core to have the core start executing the additional work assignment. During such work distribution operations as just described, a core that has completed one work assignment may be non-productive and just be waiting for CWD to assign it new work to execute. The cores are the main computation engines in example architectures, so no work is being done when core execution capacity is idle. To increase compute efficiency of the GPU, it would be highly desirable to keep each core as busy as possible.

As a simple analogy, consider a tire shop with many bays. Ideally, cars needing repair will be parked in the parking lot so that as soon as the mechanics repair a car, they can drive the car out of the repair bay and drive another car into the bay so it can be repaired. Now imagine that the time it takes to make each repair speeds up dramatically so a car is repaired very quickly after it is pulled into the repair bay, and that more and more bays are added to the repair facility so more and more cars can be concurrently repaired. This will also increase the distance between the parking spot and the repair bays. The time it takes to pull repaired cars out of bays back into the parking lot and pull cars that need to be repaired into the empty bays can slow down the entire operation, leaving mechanics idle while they wait for cars to be pulled into bays. Minimizing the time each bay is empty becomes a goal to increase the throughput of the entire operation.

### Keeping the Cores Busy

In the above example, the tensor operation was simple and quick. But suppose the operations specified by each thread block become more complex. In more complex operations such as matrix multiplication or convolution, the compute work that a thread block performs may have multiple phases. For example, a first phase might involve loading data from local memory. A next phase may be calculating the matrix multiplication. A third phase may involve post-processing the matrix multiplication output e.g., to change the numerical representation or scale of the result, perform an activation function, etc. In the automotive repair analogy above, this is a little like replacing calipers, rotors, brake pads, and tires on different wheels at different times.

When the thread block code is reasonably low throughput, each phase can keep the core busy by itself. But as throughput of the code increases, a single phase at a time is often not sufficient to keep the core busy. Generally, the phases described above may be mutually exclusive, i.e., the core can perform only one phase at a time. But some high performance solutions may allow phases to overlap, i.e., some work a core is performing is phase 1, other work the core is performing is phase 2, and still other work the core is performing is phase 3, and so on. This pipelined approach can increase core utilization for complex work although it doesn't help when the work is simple. Furthermore, to increase efficiency for such multiphase pipelined solutions, it is desirable to try to make sure all thread blocks don't try to perform the same phase at the same time, i.e., they instead stagger their concurrent processing across phases. This way, the concurrent thread blocks are not all competing for the same shared resources such as memory access, which can cause some thread blocks to wait/block. So there may be an advantage in some cases to launching different thread blocks at different times. See for example Gilman et al, “Characterizing Concurrency Mechanisms for NVIDIA GPUs under Deep Learning Workloads” arXiv:2110.00459v1 [cs.DC]1 Oct. 2021.

### Making Thread Blocks More Complex

As noted above, another solution to the above problem might be to expand the functionality of the thread blocks so they represent and perform larger amounts of work. The GPU would then not need to perform lots of completion-and-new-assignment operations. Using the car repair analogy, changing the tires and also repairing the brakes while the car is in the repair bay may be more efficient.

An approach to tackle this problem is to statically assign more work per thread-block, thereby amortizing the overheads associated with assigning work. This can be implemented in different ways such as:
Pre-assigning multiple work-items to a given compute core as discussed above.
Change the size of individual work-item itself to correspond to larger amount of work. This means distinct number of work-items in the total work set also reduce.

### Executing Multiple Thread Blocks on Each Core

For example, by assigning each core more than one thread block at a time, a core may be able to continue executing a second thread block after a first thread block completes and receive a new thread block assignment while still continuing to do work. For example, in some implementations, a core may be able to execute two or even more thread blocks concurrently. Such an approach is described in US20230289211, incorporated by reference.

Unfortunately, each of these approaches suffers from a quantization problem—if the total amount of work is not an amenable multiple of the number of cores, some cores will be left idle while others do more work. Further, typically in such a highly parallel system there's multiple unrelated tasks running, and it is difficult to predict exactly how many cores are available (see e.g., US20230289211). This exacerbates the quantization problem as there's no perfect static pre-assignment. If a large amount of work is pre-assigned to each compute core, the granularity at which new work can be assigned becomes very coarse. Consequently, high-priority work arriving later will be blocked until that previously assigned work is finished, lowering quality of service (QoS).

For example, as noted above, in many architectures CWD assigns work based on the grid or group of thread blocks as discussed above, and will not start a new grid until the current grid completes. There are good reasons for this—including for example guaranteeing concurrency for all thread blocks in the grid so dependencies can be resolved quickly without blocking. See, e.g., US20230289215's discussion of Cooperative Group Arrays or “CGAs”. At the very beginning of execution of a sufficiently large grid, the work distributor will fill all the cores with compute work, processing resource utilization will be very high, and execution will not be interrupted by frequent completion-and-new-assignment operations. Core utilization is very high at this point. Thread blocks will eventually complete, but the system may not be able to assign new work to the cores until enough of the current grid completes to leave enough cores available to concurrently execute all of the thread blocks in a next grid. So at this point, depending on the size of the grid relative to the number of available cores, there could be substantially fewer remaining thread blocks to be performed as compared to cores now freed up to perform them. As a simple illustration, suppose a grid represents 150 thread blocks and there are 100 cores available to execute the grid. Initially, each of the 100 cores is assigned a thread block, leaving 50 thread blocks of the grid awaiting execution. As the first 100 thread blocks complete, CWD assigns the remaining 50 thread blocks in the grid to be executed by available cores. However, once all 50 remaining thread blocks are assigned to cores, 50 cores may remain idle (with that number growing as thread blocks complete) until the entire grid completes and CWD can begin distributing thread blocks of a next grid. Counterintuitively in this case, increasing thread block size (average execution time) increases the time these cores remain idle, resulting in poor core utilization and degraded overall GPU throughput.

There have been some efforts in the past to increase core utilization by aggregating thread blocks to kernels. However, higher core utilization through dynamic load balancing and decreased work assignment overhead/latency is desired in modern high performance GPU architectures.

A New Approach—Separating the Worker from the Work

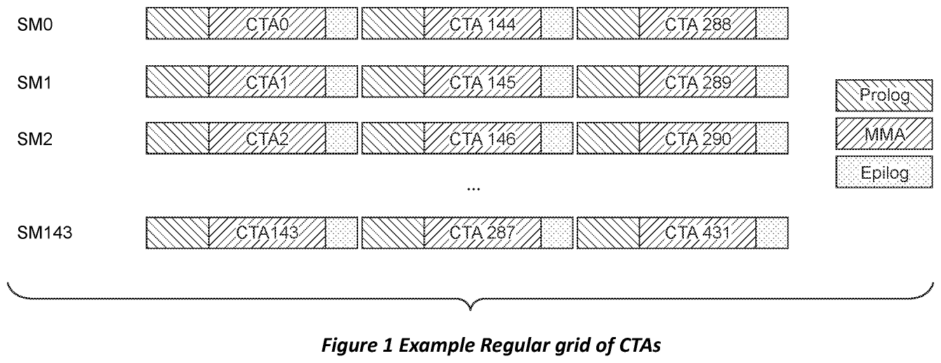

A basic problem with the above approaches is that CWD is statically assigning a given quantity of work to each worker (core) to be performed in a sequential fashion. For example, the compute work launched on GPUs is typically tiled, where each thread block computes e.g., one (1) tile of work. For typical workloads like general matrix multiply (GEMM), a single tile of work has 3 phases initial-setup (“Prolog”), main-computation (in this case MMA), and output (“Epilog”), as shown in example FIG. 1. When there are many tiles i.e. a large grid, the thread blocks are executed serially on available cores, and the cost of the initial-setup (or prolog) and output (or epilog) can add-up significantly.

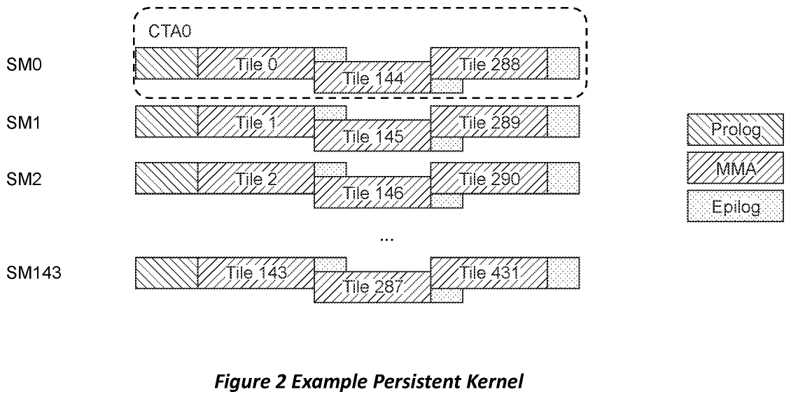

A software technique known as persistent kernels (see e.g., Zhang et al, “PERKS: a Locality-Optimized Execution Model for Iterative Memory-bound GPU Applications,” 2023 International Conference on Supercomputing (2023) doi.org/10.48550/arXiv.2204.02064) can be employed as shown in example FIG. 2. See also for example Wang et al, “Dynamic Thread Block Launch: A Lightweight Execution Mechanism to Support Irregular Applications on GPUs”, 2015 ACM/IEEE 42nd Annual International Symposium on Computer Architecture (ISCA), Portland, OR, USA, 2015, pp. 528-540, doi: 10.1145/2749469.2750393. Using so-called “persistent kernels”, a single thread block processes multiple tiles instead of just one, and different phases of each tile can be overlapped and hidden. For purposes of this example, each tile is the same amount of work as done by a thread block as in FIG. 1. While hardware support can be used, this technique can also be implemented purely in software such as by static scheduling, dynamic scheduling or a hybrid approach.

### Example Static Scheduling

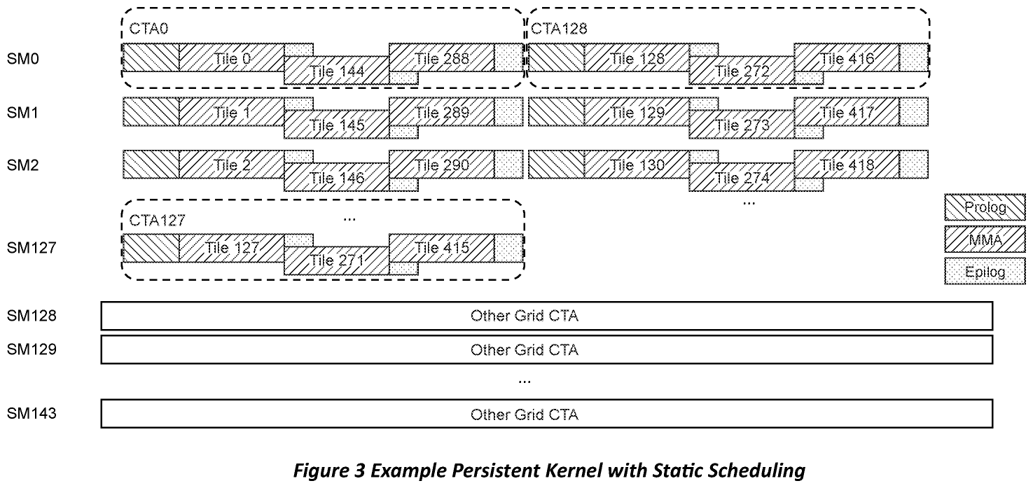

In Static Scheduling shown in example FIG. 3, the number of “workers”/thread blocks is selected (typically, this is the total number of cores) and each thread block is assigned a fixed number of tiles. An advantage of this approach is that there is zero overhead to obtain a next tile.

A disadvantage is that it is susceptible to poor imbalance if some cores are busy processing other grids.

### Example Dynamic Scheduling

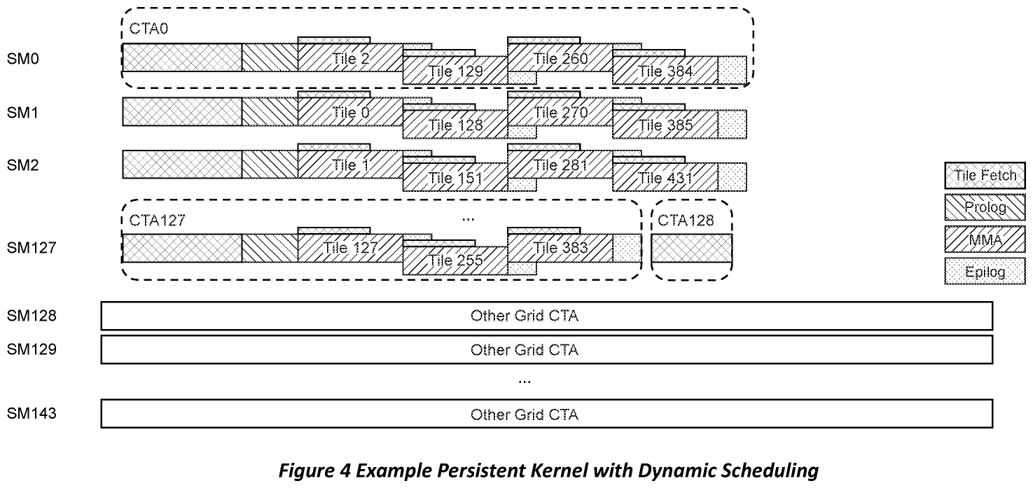

In Dynamic Scheduling shown in example FIG. 4, each thread block fetches a tile ID from a global memory atomic operation—which in some embodiments can be simply an up-counter or a down-counter. Such Dynamic Scheduling provides nearly perfect load balancing. However, this approach uses a longer prolog due to initial atomic operation, and the number of “workers” still needs to be selected. Also, in presence of other grids, some thread blocks in the end may not do any computation at all.

### Example Hybrid Scheduling Approach

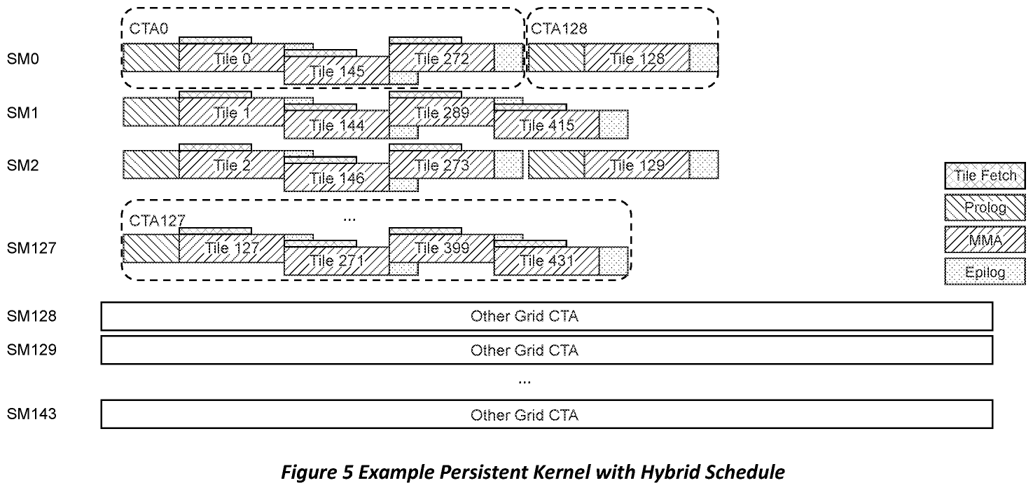

In a Hybrid Scheduling as shown in example FIG. 5, the first (or first N) tile(s) are statically scheduled, and subsequent tiles are atomically fetched from Global Memory Atomic, similar to the dynamic approach. This hybrid approach provides decent load balancing—note that the last wave of thread blocks execute only the statically scheduled tile(s). Meanwhile, the number of “workers” still needs to be selected.

### Fetch Operation Latency

For the dynamic or the hybrid approach described above, the actual tile fetch operation may have a reasonably long latency. In one example implementation, a single tile fetch operation will involve the following operations
1. All thread blocks in a group such as a CGA synchronize as “ready to accept new tile” (it is possible to use double-buffered/circular-buffered to hide latency).
2. Perform Global Memory Atomic Operation (this can involve heavy contention through multiple cache & memory hierarchies with Tensor Memory Accelerator (TMA) traffic, and many hundreds of cycles with dynamic queueing)
3. Tile ID broadcast from Leader thread block to Follower thread blocks (latency can be on the order of 100 cycles, but can be higher due to contention).

The above operations add up to a rough latency estimate of on the order of hundreds or thousands of cycles in some embodiments. In case of small GEMM workloads, this large latency can become a throughput limiter by itself. Because each thread block is now working on many tiles, such a grid cannot be interrupted by a high-priority grid, and thus the notion of priority is not honored.

### A “Grab Workload” Approach

Yet another approach is to go to the other extreme—no work is pre-assigned and instead each worker is anonymous and negotiates with its peers in software to “grab” its work item. This approach does not suffer from quantization, but the “negotiation” overhead is now on the critical path. In a large chip with multiple competing workers, even the most optimal software implementations require multiple back-and-forth transactions with non-trivial latencies in the critical path—limiting overall performance.

### A Better Solution Providing a First Class Ability to Support Persistent Kernels

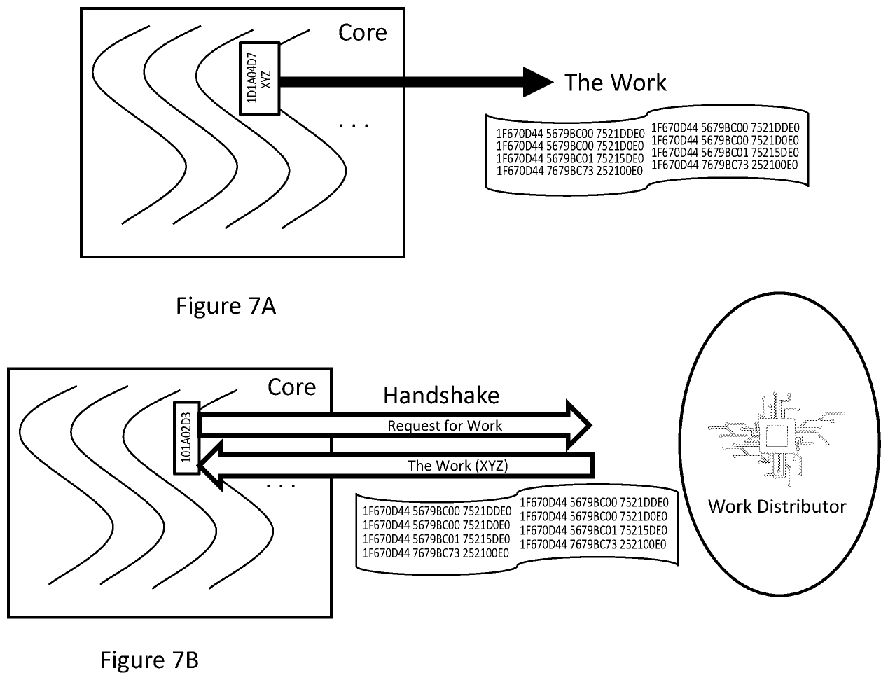

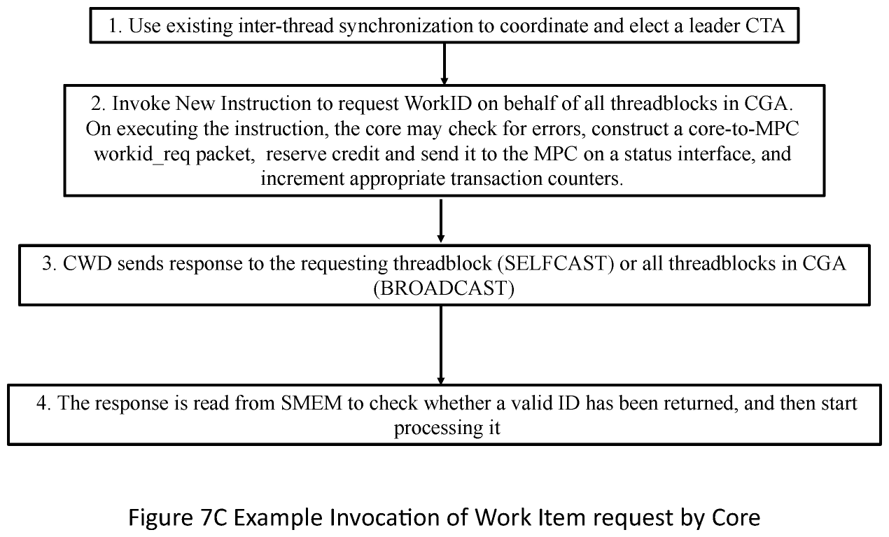

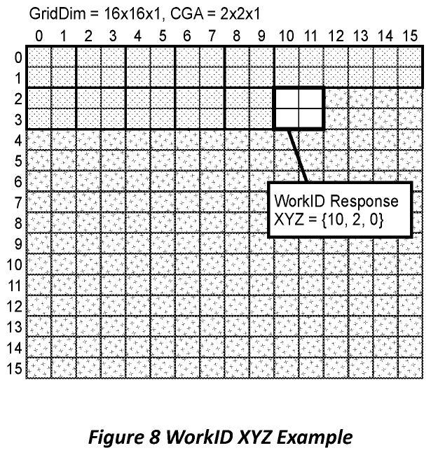

The technology herein solves these and other problems by de-coupling the notion of “launching a worker” vs. “assigning a work item”. Specifically, a particular kernel or thread block no longer fixedly corresponds to a particular work item as in FIG. 7A. Instead, the kernel or thread block is structured as a “worker” that can be dynamically assigned different work items as in FIG. 7B. The fixed equivalence between “worker” and “work” is broken so a “worker” (thread block, kernel, etc.) can perform more than one work item and/or different work items, e.g., as a work distributor assigns dynamically.

Further, the technology herein introduces a new handshake method and protocol (see FIG. 7B) between a worker and the work-distributor for work assignment, which enables the worker to provide feedback to the work distributor to enable the work distributor to dynamically load balance.

Several new hardware abilities enable such improvements:
New paradigm separating “workers” and “work-items” in hardware work distribution algorithm.
New programmatic handshake mechanism between work-distributor and workers, for adaptive work assignment.
New packets, tables & structures to facilitate such a handshake.
New mechanism to multicast or broadcast work assignment decisions to multiple sub-workers.
Synchronization semantics to assign work asynchronously, in parallel with ongoing computation.
Completion tracking protocol for graceful error handling & debuggability.

Such arrangements in some embodiments enable the following example technical features and advantages:
Programmatic interaction between worker and work-distributor enables runtime adaptability and minimizes quantization.
Minimizes high-latency back-and-forth negotiation between peer workers with a programmatically-controlled but centralized work assignment.

### Enhanced Work Distributor

In example embodiments, the work distributor (also called a compute work distributor or CWD) is enhanced as follows:
1. The CWD can launch workers and assign work-items to these workers independently. Even though the worker-launch and work-item assignment are decoupled, a new worker with no work assigned is meaningless. So, in some example embodiments, a launch is implicitly accompanied by a nominal (e.g., 1) work-items assignment. This minimizes the latency from “work launch” to actual computation execution.
2. A single worker can be assigned multiple work-items, and it can process them concurrently to saturate the computation resources available to it. This reduces the completion-to-launch latency overhead as these operations become far more infrequent instead of once per work-item. In some embodiments, the single worker can be assigned multiple work items at time of launch, and CWD can assign replacement and/or additional work as the worker completes the previously assigned work and/or more processing resources become available and/or the particular process is at a stage where (for whatever reason) capacity to do more work becomes available. This process can continue as long as needed, e.g., to complete all work. In example embodiments, work requests/queries are software-defined and is thus up to the programmer/developer instead of being predetermined by hardware.
3. CWD assigns multiple work items to workers but limits them to just sufficient to keep each worker fully occupied, in coordination with the worker.
4. This allows CWD to perform dynamic load-balancing to mitigate any tail-effects. When new computation resources become available (e.g., relinquished by other tasks), new workers are launched with remaining work. Work assignment can adapt to work-item consumption rate between different workers, either due to varying speed of workers or variation in the computation per work-item.
5. Work-set load balancing & prioritization
   The work-distributor is also actively load-balancing & prioritizing between different tasks or work-sets. Since workers may consume multiple work items and have long lifetimes, CWD can ensure a worker doesn't hog the system when its relative priority is demoted. When CWD detects that a work-set's priority has been demoted, it may indicate to specific workers to stop and relinquish resources, to which the workers respond by complying & exiting. The worker can optionally return the not-yet-processed work-items back to the CWD for future assignment.

Example embodiments solve all of the challenges outlined above by providing first class ability to support Persistent Kernels, with the following example feature set:
1. Hardware Load Balancing—Ability to adapt available cores rather than a statically selected number
2. No overhead/Zero latency for the first tile
3. Simplify next tile fetch & hide its latency.
   a. Lower latency of atomic operation
   b. Use asynchronous path to not lock a thread/warp just waiting for atomic operation.
   c. Minimize broadcast overhead for CGAs
      i. Avoid need for thread/warp for software forwarding in CGA.
      ii. Reduce the latency of broadcast by natively supporting it, instead of roundtrip through the requesting core.
   d. Pipeline multiple fetches
4. Ability for higher-priority grid to preempt persistent kernels.
5. Each CTA/thread block can now work from multiple workids designating multiple corresponding work items instead of just one to keep the processing core busy.
6. Such workids can be dynamically swapped for other workids during execution to assign new or different work without need to reinitialize.

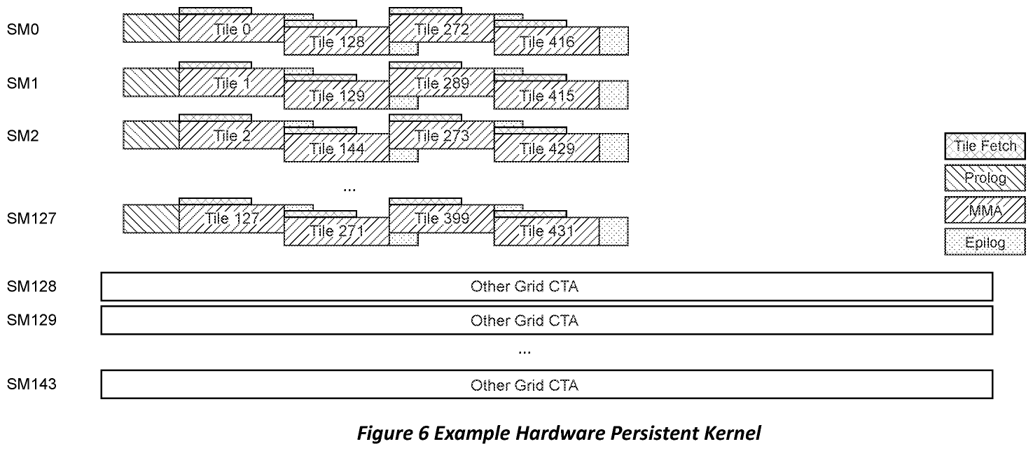

FIG. 6 shows an example of how the schedule should look like with this feature—which introduces the ability for any thread block to query for additional work, rather than exiting.

### Some Example Terminology

The following examples of non-limiting terminology may be used in discussing example embodiments herein:
“workid”—Designates a unit of work, in one non-limiting example from a grid such as a 3D grid or array
“Worker”—a thread or a Group of threads launched together (e.g., a thread block which may be called “CTA” or a group of thread blocks which may be called “CGA”).

In one embodiment, each Worker CTA/CGA when launched by CWD is preloaded with at least one (1) work item identifier (workid) (e.g., as the thread block ID/CGA ID) identifying a corresponding work item(s). It may ask for more work items as needed. In other embodiments, each Worker CTA/CGA can be launched with more than one workid designating more than one separate work item, any of which can be replaced during execution with different work items by assigning new corresponding workids in response to work item queries received from already executing thread blocks.

In example embodiments, CWD ensures that each work item needed to be processed is in fact processed on the GPU, by either launching it as a Worker-thread block or as a workid passed to existing Worker-thread block in response to a work item request from a processing core.

For new workloads that are specifically written to leverage this feature, the number of CTA launches and completions will be reduced, reducing the activity. Effectively the application runs in fewer cycles for the same grid size and overall performance will increase. In other words, in prior systems, a thread block was launched with static work item ID that allowed the thread block to look up the work it was assigned to do, but there generally was no way to change that static work ID so the thread block completed once it completed that quantity of work. In example embodiments, in contrast, the thread block can request one or more additional work assignments and receive one or more additional corresponding work IDs—persistently staying alive to execute one or more new work items while in some cases continuing to execute the original work item(s).

### Example New Instruction/API Changes

Example embodiments may thus provide an additional or changed instruction in the application programming interface (API) to support the above functionality.

In example embodiments, the developer optionally includes this new instruction in the code to be executed by a core processor. In particular, a new instruction is introduced to allow a thread already executing on a processing core to query for a new work item so it can receive and execute new work assignments. This instruction may be stored in a nontransitory memory device such as a random access memory within the processing core along with other instructions in the thread block, and executed by the processing core to control the processing core to take certain actions such as send a work item request message to the CWD.

In one example embodiment, UGETNEXTWORKID is a new uniform instruction to query whether there is another work item the worker can do and request a new workid for that work item. The instruction in one embodiment has the following format:
UGETNEXTWORKID.cast URa, URb {&req}{&rd}

In the above example instruction, the field “.cast” is defined as follows in one example embodiment:

```
.cast: {.BROADCAST, .SELFCAST}
  .SELFCAST : The result of the Work ID query is written (only) to the
  issuing thread's CTA at the specified shared memory address.
  .BROADCAST : The result of the Work ID query is written to all CTAs in
  the CGA, at the same specified shared memory address offset in each CTA.
  In case of a non-CGA CTA, the BROADCAST is still supported and acts the
  same as SELFCAST.
```

In case of a non-CGA CTA, the BROADCAST is still supported and acts the same as SELFCAST.

In the above example instruction, the field “URa” is defined as follows in one example embodiment:

```
URa: DSMEM (shared memory) Data Address.
  - Specifies the shared memory address (data_addr) where the response
  data will be written.
  - In the case of SELFCAST (or non-CGA CTA BROADCAST), the upper bits
  match the CTA ID (0 for non-CGA CTA).
```

In the above instruction, the field “URb” is defined as follows in one example embodiment:

```
URb:
  DSMEM (shared memory) Barrier Address.
  - Specifies the shared memory address (barrier_addr) of the barrier.
  - In the case of SELFCAST (or non-CGA CTA BROADCAST), the upper bits
  match the CTA ID (0 for non-CGA CTA).
```

Establishing the barrier may be as described in “HARDWARE ACCELERATED SYNCHRONIZATION WITH ASYNCHRONOUS TRANSACTION SUPPORT”, Publication No. US20230289242A1 (Sep. 14, 2023).

As explained below, each invocation of this example instruction sends a work item request from the processing core to the work distributor, i.e., to MPC>GPM>CWD. The work distributor typically responds by sending back a work item response assigning the requesting thread block new work and where to find the new work. The processing core then retrieves and executes the new work. The thread block executing on the processing core is able to programmatically judge when it should request new work in order to keep the core busy, and requests new work from CWD accordingly. In example embodiments, the dynamic work item assignment mechanism thus proceeds from a model of a “conscientious worker” who always wants to keep as busy as possible, rather than requiring CWD to monitor processing core performance/utilization in order to assign work when CWD determines it may be needed (a GPU chip can of course include performance/utilization monitoring to help a developer detect when a thread block is not “conscientious” or is otherwise faulty during development and/or halt operations in real time if processing is going awry).

Example I: Software Kernel Program pseudocode showing a very simple non-persistent baseline kernel:

```
_{——}device_{——} regularKernel( ) {
  S2R workID; // Read the workID whenever needed in the kernel
  // Do whatever
}
```

In this context, a “kernel” is simply software that executes on the GPU. It should not be confused with an operating system kernel, which is a different concept altogether.

Example II: Software Kernel program pseudocode showing a kernel with persistency ability by invoking the UGETNEXTWORKID instruction:

```
// New kernel which has persistency ability
_{——}device_{——} newPersistentKernel( ) {
  do {
    regularKernel( );
    predicate, newWorkID = UGETNEXTWORKID;
    if(predicate == success) {
      SETworkID newWorkID; // Update the WorkID
    }
  } while (predicate == success);
  exit( );
}
```

Example III: software Kernel program pseudocode that sets up a data structure and then performs a computation based on the data structure that has been set up:

```
_{——}device_{——} setUpCommonDataStructures( ) { ... }
_{——}device_{——} doCoordinateSpecificCompute( ) {
  S2R workID; // Read the workID whenever needed in the kernel
  // Do whatever
}
// Non-persistent kernel for reference
_{——}device_{——} regularKernel( ) {
  setUpCommonDataStructures( );
  doCoordinateSpecificCompute( );
}
// New kernel which has persistency ability
_{——}device_{——} newPersistentKernel( ) {
    setUpCommonDataStructures( );
    do {
      doCoordinateSpecificCompute( );
      predicate, newWorkID = UGETNEXTWORKID;
      if(predicate == success) {
        SETworkID newWorkID; // Update the WorkID
      }
    } while (predicate == success);
    exit( );
}
```

The above example initializes the common data structures for the first work item and then keeps reusing that data structures for all subsequent work items.

Example IV: software Kernel program pseudocode with multiple phases that sets up a data structure with some threads (phase 1) and then with other threads (phase 2) performs in a pipelined manner, a computation based on the data structure that has been set up:

```
_{——}device_{——} setUpCommonDataStructures( ) { ... }
_{——}device_{——} doCoordinateSpecificCompute_Phase1(dim3 coordinates) {
  // Do phase1 computations using provided ‘coordinates'
  _{——}shared_{——} phase2_coordinates = coordinates; // Set up coordinates for phase2 compute
}
_{——}device_{——} doCoordinateSpecificCompute_Phase2( ) {
  // Use software managed coordinates passed from phase1
}
// Non-persistent kernel for reference
_{——}device_{——} regularKernel(...) {
    setUpCommonDataStructures( );
    dim3 workCoordinates = S2R_workID;
    doCoordinateSpecificCompute_Phase1( workCoordinates );
      doCoordinateSpecificCompute_Phase2( );
}
// New kernel with full persistency ability
_{——}device_{——} newPersistentKernel(...) {
    setUpCommonDataStructures(...);
    dim3 workCoordinates = S2R_workID;
    // Start the warp-specialized pipeline
    if (threadIdx.x % 32 < FEW_WARPS) {
      doCoordinateSpecificCompute_Phase1( workCoordinates );
    }
    do {
      if (threadIdx.x % 32 >= FEW_WARPS) {
        doCoordinateSpecificCompute_Phase2( );
      } else {
        predicate, newWorkID = UGETNEXTWORKID;
        if (predicate == success) {
          doCoordinateSpecificCompute_Phase1( newWorkID );
        }
      }
    } while (predicate == success);
    exit( );
}
```

In the above “full persistency” example, as soon as some threads complete phase 1 to set up a data structure, those threads ask CWD for more work while other threads perform computations on the data structure in phase 2. When CWD responds with a new work assignment, the requesting threads begin performing phase 1 of the new workid. Thus, the software loops to (1) do phase 2 on other threads while (2) requesting additional work from CWD and doing phase 1 processing on that new work. This example can be extended to any number of phases to maintain phase overlap while saving the cost and overhead of initialization and getting the benefit of dynamic work assignment. The thread block can slice up the processing resources of the processing core into different phases (m threads are performing phase 1, n threads are performing phase 2, and so on) each working on different workids, to provide a staggered pipeline of execution. In example embodiments, the hardware need not have any notion of phases, which can be an entirely software construct.

### Example Work Item Request Operating Sequence for CGAs

The following sequence of operations shown in FIG. 7C may be performed in example embodiments after CWD launches a CGA:
1. Use existing inter-thread synchronization to coordinate and elect a leader thread.
2. Execute new instruction (e.g., UGETNEXTWORKID) to request a work item on behalf of the Thread block (CTA) or group of thread blocks (CGA). As noted above, there can be multiple work item requests in flight from the same CTA or CGA.

On executing this instruction, the core may check for errors, construct a workid_req packet for sending to CWD, and increment appropriate transaction tracking counters. In example embodiments, the requesting processing core (thread block) has a choice: there is a self-cast variant where response is sent only to the requesting CTA, and a broadcast variant where responses are sent to all the thread blocks in CGA. In example embodiments, symmetric destination & barrier shared memory addresses apply across all thread blocks (processing cores). Thus, in an example embodiment, the requesting thread block can send a work item request that pertains only to itself, or it can send a work item request that a group of thread blocks executing concurrently with it all need to know about.
3. CWD receives the workid_request and sends a response to the requesting thread block in case of SELFCAST, or the response is broadcast to all thread blocks in CGA in case of BROADCAST. Each CTA/core handles the response similar to other memory responses and writes it to shared memory. The barrier is updated to indicate the arrival of response.
4. The response is read from shared memory to check whether a valid ID has been returned, and then the thread block starts processing it.

See the following example pseudo-code:

| Leader thread block in CGA (or a non-CGA | |
|---|---|
| CTA) | Follower CTA(s) in CGA |
| SYNCS.ARRIVE ...; // Inform threadblock | SYNCS.ARRIVE ...; // Inform threadblock |
| leader (self) that ready to accept new | leader that ready to accept new threadblock |
| threadblock ID. | ID |
| !@P0 SYNCS.PHASECHK.TRYWAIT ...; // Wait | ... // Do some other compute work |
| for all threadblocks to be ready for new | SYNCS.PHASECHK.TRYWAIT Rb; // wait for the |
| ID. | barrier to clear i.e. response to arrive. |
| !@P0 UGETNEXTWORKID.BROADCAST [URa]; // | ... // Decode response from CWD in |
| URa = Destination shared memory address for CWD | software, resulting Pd = 1 for GRANTED or 0 |
| response. URa+1 = Barrier shared memory | for DECLINED |
| address to wait on. | @!Pd BRA EXIT_LABEL; // Jump to exit if |
| ... // Do some other compute work | predicate isn't set. |
| SYNCS.PHASECHK.TRYWAIT Rb; // Wait for the | BRA PROCESS_NEW_ID_LABEL; // Read |
| barrier to clear i.e. response to arrive. | and process new work item |
| ... // Decode response from CWD in | |
| software, resulting Pd = 1 for GRANTED or 0 | |
| For DECLINED | |
| @!Pd BRA EXIT_LABEL; // Jump to exit if | |
| predicate isn't set. | |
| BRA PROCESS_NEW_ID_LABEL; // Read and | |
| process new work item | |

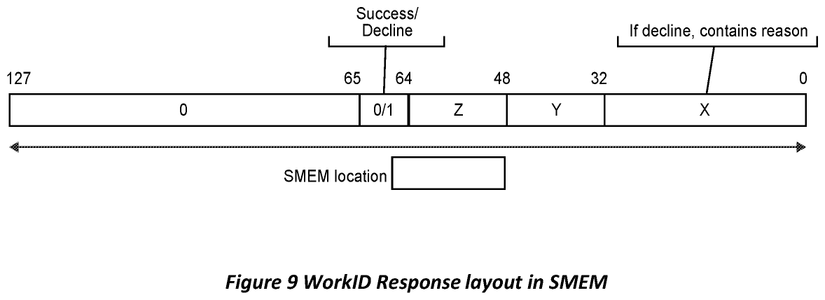

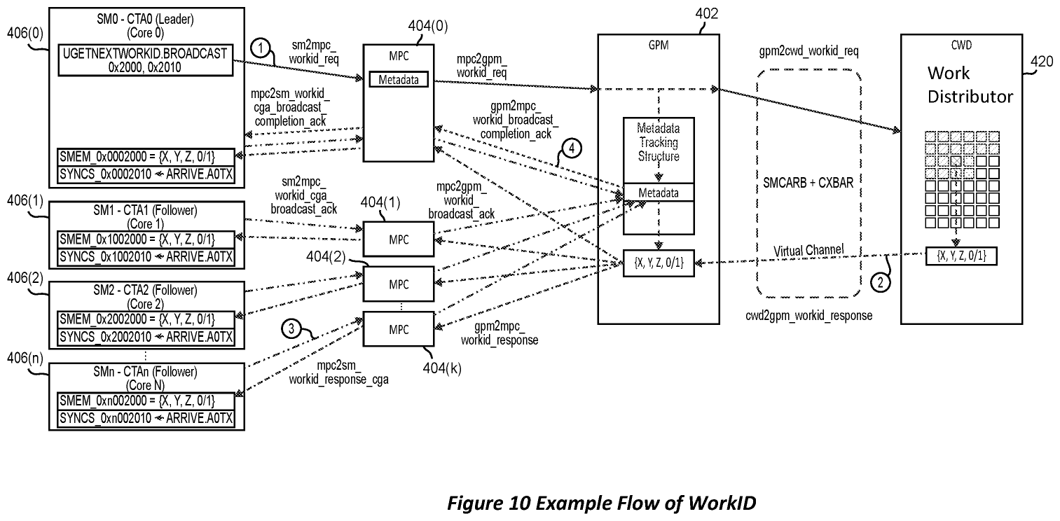

In example embodiments, a single work item request/response always corresponds to a whole CGA (or CTA if legacy CTA). In context of CGA, a work item response in one embodiment will only provide the base CTA ID corresponding to the CGA regardless of which CTA-in-CGA requested the ID. See FIG. 8 as an example. In one embodiment, the response is stored in the shared memory in format shown in FIG. 9. It is up to user/software to appropriately add the CTA rank to it, and ensure that all CTAs within CGA do receive & process their IDs.

In one example non-limiting embodiment, CWD is empowered to decline new work requests under certain circumstances. In such embodiment, a “declined” work item request may but does not necessarily indicate “end of grid” (see below) so user/software should not assume this. Rather, in such embodiment, each work item request is an independent asynchronous operation, and the user should check response to every request independently, and not rely on order of operations. Depending on the reason for a decline, one decline does not guarantee or even indicate a future decline. In more detail, example embodiments provide mechanisms of servicing a work assignment request by *sometimes declining* it instead of awarding a new work item. And in such embodiments, the thread block *must exit* if it receives a declining response. This feature serves a few important functionalities in example embodiments:
1. Terminates thread blocks and the entire kernel/grid in the GPU. When CWD receives a request and there are no more work items left in the grid, it sends a decline to the requester. When the requesting thread block receives the decline response, it must exit after finishing already awarded work items. Otherwise, the persistent thread blocks hang around and waste execution units which are otherwise available for other kernels.
2. CWD prioritizes filling a newly available execution unit over awarding already running thread blocks. This is important from a load balancing point of view. CWD's primary job is keeping busy as many execution units as possible. For example, if there is only one work item left in the grid, and one execution unit becomes available and one work assignment request arrives at the same time, CWD must launch a new thread block to the execution unit since presumably the work requesting thread block is already busy working on previously awarded work item. Making the empty execution unit busy is more important.
3. If CWD finds other kernels/grids that should be launched immediately (for example the kernel is higher priority), CWD must stop launching thread blocks for the current kernel (of course) but also it must decline all work requests from the kernel so that all thread blocks promptly exit and make space for the new kernel. Once the new kernel exhausts work items, CWD can switch back to the original kernel and start launching thread blocks and awarding work items.

### Example Handshake Mechanism

In example embodiments, the aforementioned handshake mechanism for work assignment may be implemented as a programmatic ability on the worker to “request for a work item”. In particular:—
A worker can request more work-items when it is near the completion of currently assigned work-items and forecasts the need for more. This request is processed by the WD and new work-item is sent as a response.
The programmatic usage of this ability, depending on workload, also serves as a feedback mechanism from worker to CWD on work-item consumption rate, aggressive or measured. Such feedback for example means CWD does not assign work too aggressively (e.g., giving new work to a process that does not yet have resources to perform it) or too conservatively (e.g., so resources that could be used to perform new work are underutilized), too early (making load balancing challenging) or too late (exposing undesired latency). Since the work request instruction is under control of the developer/programmer, the developer/programmer can tune their programs to request additional work just in time.
Because this worker is still processing currently assigned work items, this operation may be implemented in a non-blocking manner, such that it can complete in background. Consequently, the request may also contain the synchronization entity to track completion.
When CGAs (see US20230289215) are used, the whole CGA can be treated as a single worker to honor simultaneity/concurrency guarantee, and each constituent CTA (thread block) inside the CGA may be informed of the new work-items directly or indirectly.

To make such a request, the programmer provides in one example embodiment:
1. Destination shared memory address—The memory location where the response from the work distributor is written. To interoperate with CGAs, this is a symmetric offset into each CTA's distributed shared memory (see US 2023-0289189).
2. Synchronization entity to track completion—This is the barrier (see US 2023-0289242) to keep track completion of one or multiple such operations. For CGAs, it is symmetric across all the target CTAs to allow completion tracking at each target CTA individually.
3. Destination CTAs in a CGA that receive work-items directly: This can be in the form of specific annotations—“selfcast” or “broadcast”, or a more flexible multicast with a list of destinations or an encoded bit-vector. One example non-limiting implementation uses direct annotation for simplicity—selfcast (only 1 CTA that requested) or broadcast (all CTAs in a CGA). In other embodiments, the programmer may provide additional metadata like the current thread block ID or row ID or column ID to guide selection of the next work-item in CWD circuitry along preferred structured pattern (same row or same column etc.)

Such a request can originate from one CTA (on a processing core) while responses may be sent to multiple CTAs in CGA (on other processing cores), so all this information is carried with the request itself.

A new packet type may be used for this to flow from a core (which houses the worker) to CWD (the work distributor), and then a corresponding new response packet is sent to the different cores as denoted on the request. The network between core<=>CWD may be enhanced to carry these packets, append metadata as necessary along the route, or park the metadata information at the closest common point if not needed any further, and eventually utilize it to replicate the response & broadcast packets. In some embodiments, this hardware appended metadata may be used as additional information to guide the scheduling algorithm for structured locality, without explicitly asking it from the programmer.

Because the responses are sent to multiple destinations, each destination may run into different errors individually. To ensure that all these errors are deterministically attributed, in example embodiments a final completion ack(knowledge) is sent from each receiver, coalesced in the network and sent to the CTA which initiated the request. This final completion ack(knowledge) denotes completion of the transaction, and the coalesced errors, if any, are raised through an error attribution mechanism.

Once the synchronization barrier is updated, the response data written in the denoted memory can be decoded by the program. In one example embodiment, the response data received from the work distributor contains:
Success or decline: Whether CWD granted a new work-item or declined.
Work-item identifier: This is the unique identifier in the work-set/grid.
in example embodiments, if the request was declined, the payload instead contains Decline reasons, namely a decline code to indicate the reason for the decline, which the programmer may choose to act upon. In other embodiments, the response may also contain additional metadata which may be used for other scheduling actions or as metadata for future workid requests.

### Example Message Communication and Synchronization Circuits

In example embodiments, the core processor making the work item request does not talk directly to CWD, and CWD does not talk directly to the core processor. Rather, there is “middle management” circuitry between them used to handle the complexity of many (potentially hundreds or thousands) of core processors asking CWD for work assignments while also relieving CWD of mundane but important tasks that can be offloaded from it.

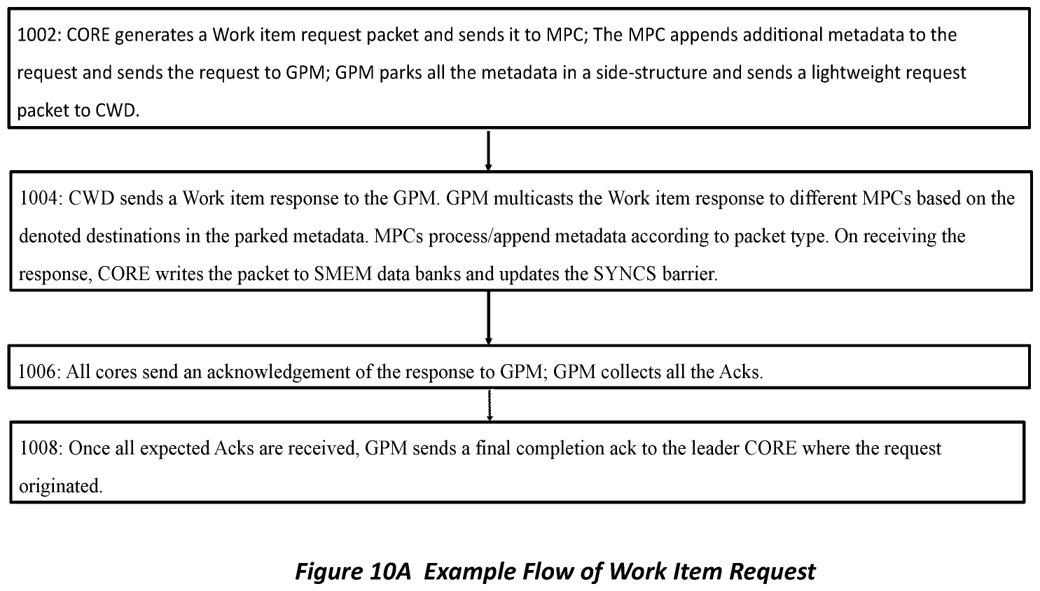

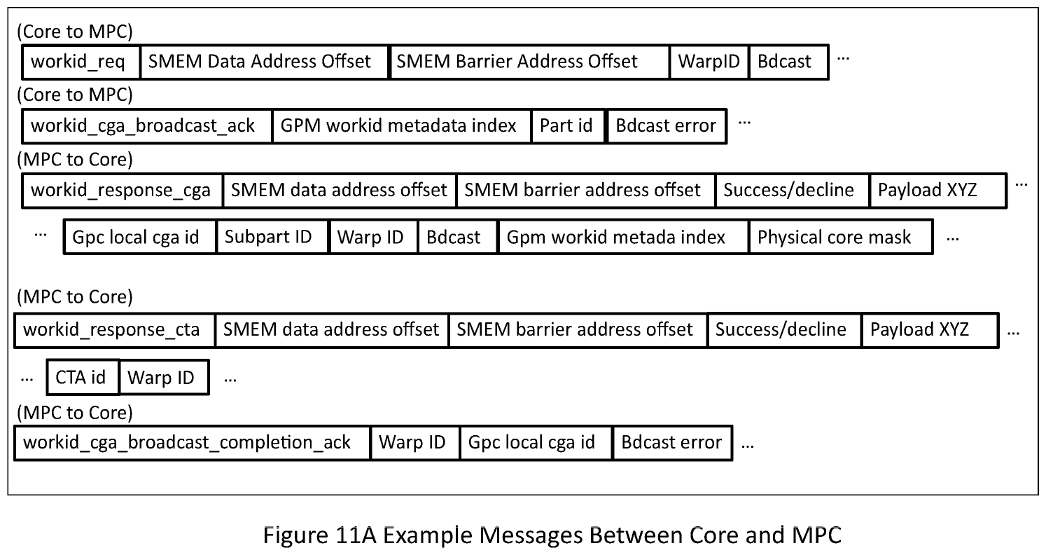

FIG. 10 shows an example architecture showing N processing cores on the lefthand side with core 0 being the leader requesting the work item assignment, and cores 1-N being followers. CWD work distributor circuit on the righthand side is shown developing and sending the requested work assignments back to the core processors. In between the core processors and CWD are shown three layers of “middle management” circuitry:
MPC (M-pipe controller) circuits
GPM synchronization circuits
SMCARB and CXBAR communication circuits.

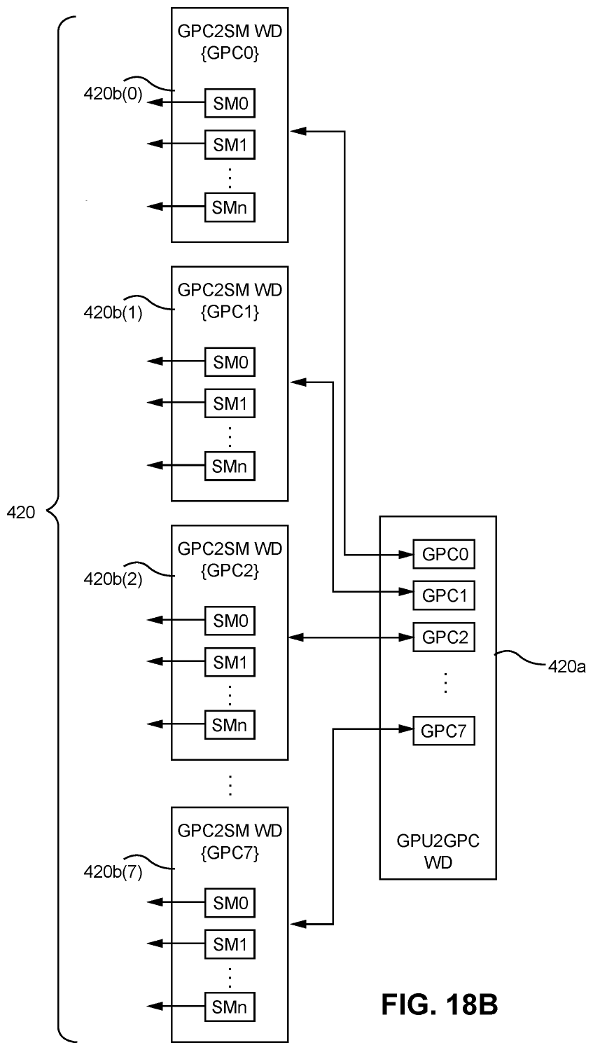

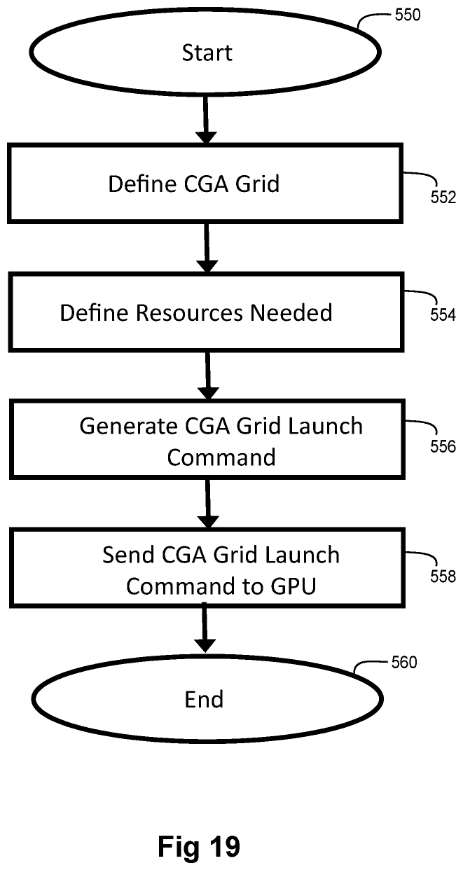

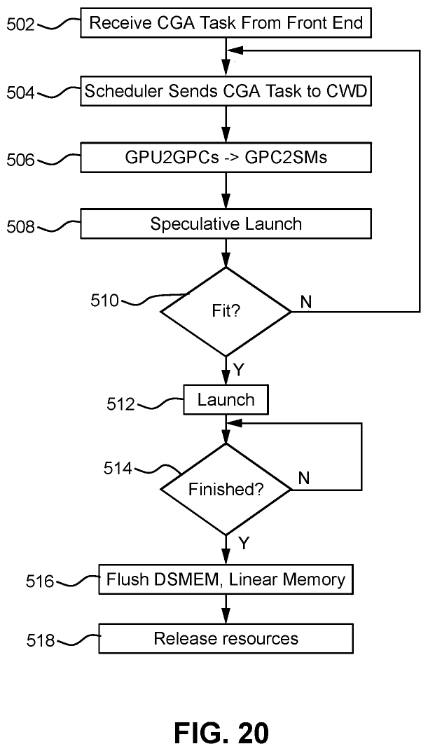

These circuits (present in prior GPU designs) perform a variety of conventional functions, but in example embodiments they have been enhanced as described below to provide additional or different functionality to support work item requests, work item responses, and other features relating to the functionality described herein. More information concerning conventional structure and operation of these circuits can be found for example in FIGS. 18A-18B, 19, 20, corresponding to FIGS. 13 through 16-2, 18-A and associated description of US20230289211, incorporated herein by reference. Example hardware changes to the existing circuits of prior platforms may include:

| Sub-feature | Hardware Units impacted |
|---|---|
| New instruction for workid | SM processing cores, LST |
| Adding information on Packet | MPC |
| for work item request | |
| Common point for broadcast | GPM |
| new virtual channel | SMCARB |
| Grant new workid | CWD work distributor |

As FIGS. 10 & 10A show, in example embodiments the work item request instruction flows from the processing Core 0 through the Front Pipe of the GPU with wires shared by the launch & completion paths. These Figures show an example high-level flow for a broadcast transaction as follows:
Step-1 (FIG. 10A block 1002)
CORE (only one) generates a work item request packet and sends it to MPC.
The MPC appends additional metadata to the request and sends the request to GPM.
The GPM parks all the metadata in a side-structure and sends a lightweight request packet to CWD through SMCARB/CXBAR.
Step-2 (FIG. 10A block 1004)
CWD sends a work item response to the GPM via a virtual channel through SMCARB/CXBAR.
GPM multicasts the work item response to different MPCs based on the denoted destinations in the parked metadata.
MPCs process/append metadata according to packet type and send or broadcast the work item response to corresponding processing cores.
On receiving the response, each core writes the packet to its shared memory data banks and updates its local SYNCS barrier.
Step-3 (FIG. 10A block 1006)
All cores send an acknowledgement of the response along with optional error information, if any, to GPM via associated MPCs.
GPM collects all the Acks and coalesces error information, if any.
Step-4 (FIG. 10A block 1008)
Once all expected Acks are received, GPM sends a final completion ack to the leader core where the request originated. In example embodiments, there is no need to bother CWD with completion status since CWD's job is to assign work in example embodiments CWD assigns work based on work item requests initiated by the cores. (In other embodiments, CWD could provide additional functionality to originate additional work assignments based on completion status).

### Example Message Formats

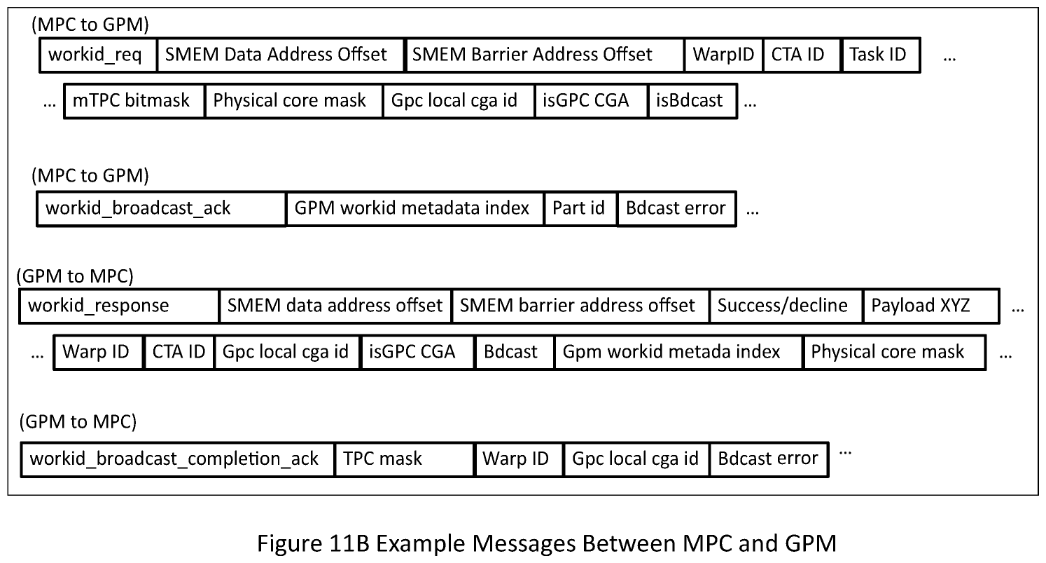

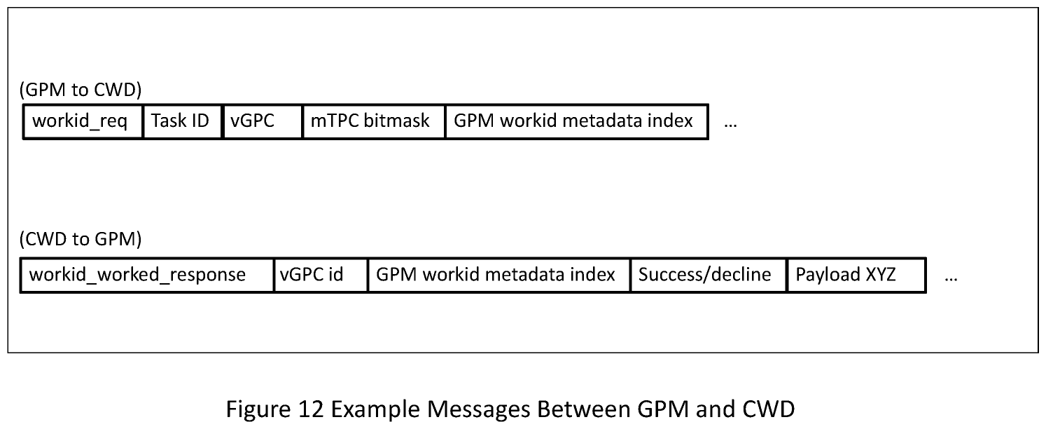

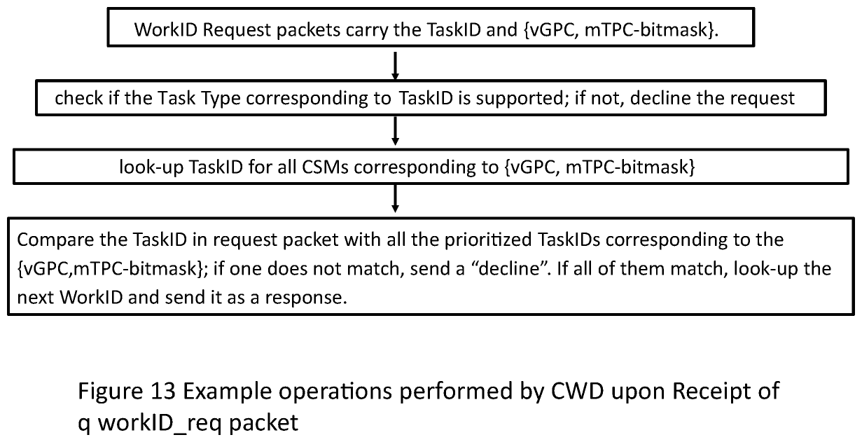

FIGS. 11A-11B, 12 show new messages the example embodiment uses to communicate between the various circuits described above. FIG. 10 shows legends such as “sm2mpc” and “mpc2sm” to refer to messages sent between processing cores (SMs or streaming multiprocessors in one particular implementation) and the MPC circuit as shown in FIG. 11A. Similarly, the FIG. 10 legends “mpc2gpm” and “gpm2mpc” refer to messages sent between the MPC circuit and the GPM circuit, as shown in FIG. 11B; and FIG. 10 legends “gpm2cwd” and “cwd2gpm” refer to messages sent between the GPM and CWD as shown in FIG. 12. It should be noted that there are different “flavors” of messages such as workid_req depending on the layer where the message exists, and that the different circuits transform, add to and/or take away from those messages as needed in the manner described below (so that for example the workid_req message the core sends to the MPC has a different format than the workid_req message the MPC sends to the GPM, and so on).

### Example Request Path Deadlock/HOL Blocking Prevention

In above arrangement, the wiring between different circuits may also be used by other messages which originate & terminate at different points, and may be ‘blocking’ by design. Cross-interaction between these other messages and workid messages may cause deadlock. Consequently, example embodiments would benefit from a guarantee that path is always non-blocking, or by provisioning virtual-channel (VC) for the blocking messages.

In particular, example embodiments could benefit from making sure work item request packets don't head-of-line block other types of packets using the same interface. CWD in example embodiments provides a forward progress guarantee i.e. regardless of what else is happening, CWD may process work item requests within finite time. That should be sufficient to guarantee that request (GPM->CWD) path is deemed non-blocking.

Forward progress guarantee inside CWD

In example embodiments, it is helpful for CWD to provide a forward progress guarantee for work item requests. Even though CWD's outgoing path has a virtual channel (VC) in some embodiments for work item responses, its internal launch pipeline itself might be halfway through processing a launch. And if the compute VC is back-pressured, this pipeline might stall.

In one example embodiment, CWD starts a watchdog timer whenever a work item request loses arbitration to a launch with same TaskID AND that launch is not making forward progress due to lack of credit on the launch VC. If there's a timeout, CWD will bypass the launch pipeline and directly generate a “Decline” for the work item request. The exact timer duration may be tuned for worst case.

Once the watchdog timer is expired, the timer should stay expired, and all subsequent requests should be declined until launch credits are returned. All requests should be serviced rapidly until there is an indication of launch-path-backpressure being cleared (returning launch credits).

In addition, to prevent imbalance between cores and reduce interference on the SM→GPM path, the core may ensure that it does not send any more requests than what GPM can process at a time. The core may for example track total outstanding requests and self-throttle to never exceed a maximum number of work item requests per core. This also guarantees that work item requests sent from MPC will always be processed by GPM without any internal stall providing non-blocking behavior. Additionally, because work item Broadcast Acks are also tracked on the same metadata structure, this also guarantees that all Acks can always be accepted by GPM and provide non-blocking behavior. A response path from (CWD==>Core) also implements a virtual channel to ensure the non-blocking behavior.

### Processing of Requests by CWD

In example embodiments, it is CWD's responsibility to ensure that each work item is processed once and only once on the GPU. It can do so by launching a work item as a new WorkerCTA, or by sending it as a response to a work item request from an existing WorkerCTA. In case free resources/cores are available, CWD may prioritize launching new Worker CTAs to maximize core occupancy and optimum load balancing. CWD can launch original and new Worker CTAs as shown/described in FIGS. 18A-18B, 19, 20, corresponding to FIGS. 13 through 16-2, 18-A in US20230289211 (and see also other Figures of that prior filing), taking into account other workloads the system already is performing and needs to perform as well as other factor such as guaranteeing concurrent processing of all CTAs in a CGA. Such launching algorithms and other description in US20230289211 is not repeated here for the sake of brevity, but is specifically incorporated herein by reference as if expressly set forth.

In example embodiments, CWD retains control over scheduling and load balancing etc. and is thus (as described above) the circuit that assigns or declines to assign work to a processing core in response to a workid_req request message that the core sends. CWD also tracks which work it has assigned and which work remains to be assigned to avoid duplicate work assignments (the work in each grid should be performed once and only once).

The processing core (thread block) has no visibility into how much other work CWD needs to assign, but the processing core (thread block) can ascertain its own work situation (e.g., whether it has or will soon run out of things to do) and—through inter processor core communication with other thread blocks in the same CGA or from broadcasts of dynamic work assignment responses—may also be able to ascertain (e.g., based on synchronization barrier mechanisms) how much work other workers (thread blocks) in the CGA have left to do. In example embodiments, the processing cores (thread blocks) themselves can programmatically, dynamically determine if they need more work, and if so, request CWD to dynamically assign more work. There is no requirement for CWD or the system to specify, at launch time, the total amount of resources needed to perform the work to completion. This is a huge advantage since in a modern GPU there can be many different unrelated workloads that complete or don't complete based on many different factors including dependencies, memory latency, etc. —so the resources available to perform any given workload at any given time can change dynamically and usually cannot be reliably predicted in advance. In example embodiments, the software specifies the work that has to be done, the hardware selects a variable number of workers based on available resources, and the hardware scheduler—handshaking with the executing workers—assigns more work as previously assigned work is completed and/or more resources become available. The CWD thus continues to be responsible as it has in the past for reserving processing resources to perform given work, but example embodiments further provide dynamic feedback from executing software workers that enables CWD to dynamically perform load balancing. For example, if some workers are delayed from completing their Work-items due to e.g., waiting for resources to become available or are taking a longer time to complete because their assigned Work-items are more computationally complex, feedback CWD receives from the software allows CWD and thus the GPU to dynamically load balance. Cores that are running slower and/or otherwise taking longer to complete assigned work will naturally generate fewer requests for additional work. CWD therefore does not try to assign such cores more work until they have finished their current assignments and request more work. CWD meanwhile assigns additional work to the cores who are completing their work more quickly because they are generating work item request messages (workid_req) requesting more work from CWD, thus providing dynamic feedback to CWD concerning actual dynamic utilization of the processing cores.

It is then up to CWD in response to the request to assign more work or to decline the request and not (for the moment at least) assign more work to the requesting processing cores (thread blocks). In example embodiments, this process is performed without the overhead needed to start and stop workers. It's a little like hiring permanent employees and assigning them to do whatever the boss needs them to do as compared to onboarding temporary employees or contractors for individual tasks and then offboarding them as soon as they have completed the specific tasks assigned to them. Furthermore, example embodiments provide a very fast, highly efficient mechanism for transporting and processing additional work requests, additional work assignment responses, and other associated messaging. Furthermore, these operations in example embodiments are asynchronous so there is no blocking and workers can continue to work on remaining work they still have left to do after they request additional work and even after CWD assigns additional work (recall the multi-phase pipelined work description above). This is a little like an employee telling the boss they expect to be done with their current work assignment soon so the boss can come up with new work assignments for them—except that in example embodiments the worker is able to continue working on their current work assignment(s) to completion while at the same time using spare processing core capacity to start concurrently performing one or more new work assignments.

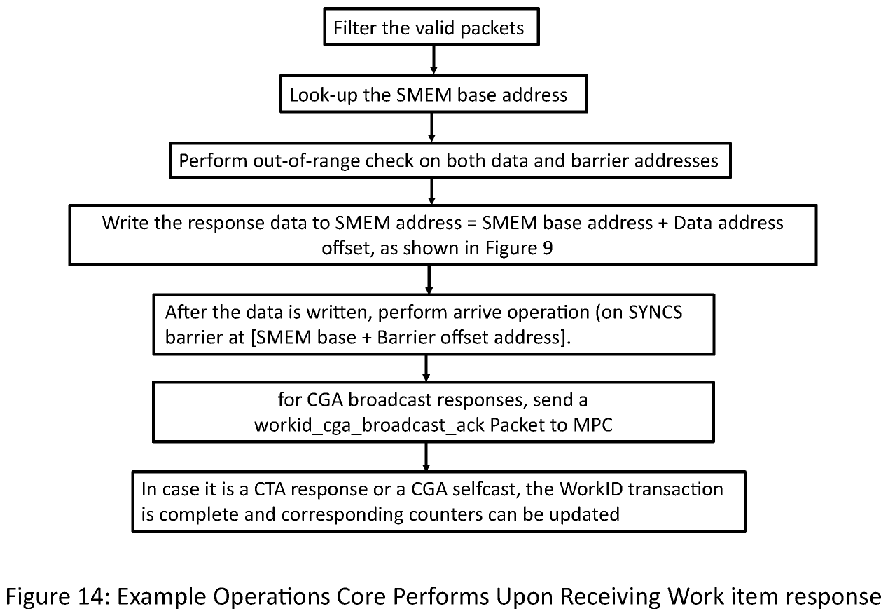

In one example non-limiting embodiment shown in FIG. 13, workid_req work item request packets carry the TaskID and {vGPC, mTPC-bitmask}. (the mask indicates all the TPCs that contain this CGA). In such embodiment, not all Task Types are suitable to use with workid mechanism, so CWD checks if the Type corresponding to TaskID is supported and declines the request if it is not. In such embodiment, CWD internally maintains prioritization information between different taskIDs per TPC separately. CWD looks up the taskIDs for all the TPCs corresponding to {vGPC, mTPC-bitmask} and compares the TaskID in the packet to ensure that that specific TaskID has not lost priority. If even one of them doesn't match, indicating lost priority, CWD returns a “Decline” with a reason. If all of them match, CWD looks-up the next workid of the next work item to be assigned and sends it as a response in a format as shown in FIG. 9 (which is deposited in shared memory so the requesting processing core can access it).

In example embodiments, the X, Y, Z payload values in the work item response correspond to the XYZ coordinate of the next CTA in the grid (for non-CGA CTAs) or the XYZ coordinate of the first CTA of the next CGA in the grid (for a GPC_CGA). FIG. 8 shows an example of this. XYZ can be thought of as an index into a three-dimensional array of work. The XYZ-indexed CTA is itself a Thread block (in case of CGA) that CWD could newly launch to independently execute on a processing core. In example embodiments, CWD may instead determine to assign this unit of work to be executed by a thread block that is already executing on a processing core. Nothing special needs to be done for workid to accomplish this the CTAs which can be launched independently vs. assigned to existing workers may be exactly the same. The CGAs may have a structure requirement both for launch as well as assignment as described in “Cooperative Group Arrays”, Publication No. US20230289215A1, Publication Date: Sep. 14, 2023.

### Example Decline Reasons

As described above, in example embodiments, CWD can choose to decline work item requests for various reasons including for example load balancing and prioritization. For example, CWD can decline (permanently or only temporarily) to assign additional work to some requesting processes in order to free up resources for higher priority tasks (in some cases the decline may be “sticky”, in other cases CWD can again begin assigning additional work to already-executing thread blocks when the higher priority task completes). Whenever CWD declines a request, it may annotate the decline reason instead of a workid designating a new work item in the response packet. Software can potentially use these reasons to take appropriate action.

In example embodiments, CWD does not guarantee that it will decline any subsequent requests inflight to a thread block once it has already declined a request for that CTA. In example embodiments, software may check response to every request independently and not rely on order of responses.

Below are example possible decline reasons:

| Reason | Remark |
|---|---|
| Unsupported | GPU_CGA, GPU_GPC_CGA, |
| Type | |
| End of Grid | No more work |
| No large CGA | Flexible CGAs specific - |
| left | no more large CGAs are left, but grid not yet complete. |
| Timeout | When watchdog timer expires |
| thread block | |
| Preemption | |
| TaskID | task deallocation due to priority grid or sub-context |
| Eviction | scheduling |
| Priority Switch | When high-priority grid is small, the previous grid |
| (without | can come back quickly and start servicing requests again. |
| TaskID | With multiple workid requests in flight, first request |
| Eviction) | may get a decline while second one gets a valid response. |

### Example Completion Tracking

Grid rasterization completes when all Work IDs are “launched”, either as fresh Workerthread blocks or passed to existing Worker thread blocks. In example embodiments, CWD tracks how many Worker thread blocks are alive at any given moment. It need not track how many workids are actually completed/being-processed/in-flight. Once there are no more alive Worker thread blocks and grid rasterization has completed, the grid is done and can initiate grid-ending MEMBAR.

### Example Handling of Workid Transactions by Processing Cores

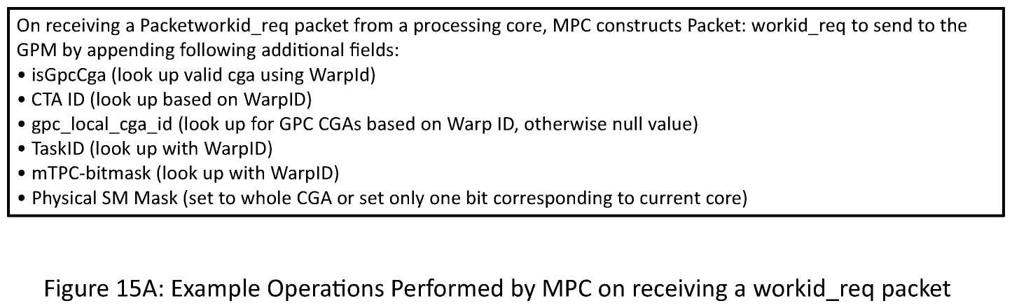

FIG. 14 shows example handling of workid transactions in each processing core.

On receiving the workid response from the MPC, the processing core may perform following actions:

Filter valid packets to ensure the packet is for the particular core processor (e.g., use physical processing core mask or part_id to determine whether to process or drop the packet).

Look-up the shared memory base address using CTA ID or gpc_local_cga_id; raise an error (directly or as part of an Ack packet) if this process fails.

Perform out-of-range check on both data and barrier addresses and write the response data to shared memory address=SMEM base address+Data address offset, as shown in FIG. 9 (either X, Y, Z or Decline Reason).

In example embodiments, a synchronization entity (barrier) is used to ensure that responses to dynamic work assignment requests come back. Meanwhile though, since there may be some instances where CTAs in a CGA do not request broadcasting of dynamic work assignments to all other CTAs in the CGA, the programmer has a choice of specifying “broadcast”, “selfcast” or (in some implementations, “multicast” to only some or certain specified workers such as those having a “need to know” but not others) for such returned dynamic work assignments.

Thus, after writing the data to shared memory, the processing core then performs an “arrive” operation on the appropriate SYNCS barrier at [SMEM base+Barrier offset address] to update the barrier object. Additionally, for CGA broadcast responses, the processing core may send a workid_cga_broadcast_ack packet to MPC.

In case it is a CTA response or a CGA selfcast, the workid transaction is complete and corresponding counters can be updated. For CGA broadcast, GPM may send a separate completion packet.

For CGA broadcast requests that originated from a CTA on this processing core, GPM sends responses to all the CTAs in the CGA, receives Acks from all of them, and finally sends a coalesced Completion Ack to the requesting software thread block indicating completion of the transaction. This efficiently informs all processing cores executing CTAs in a CGA about the state of other CGA-related work assigned to each processing core. Hardware in this way keeps all workers assigned to a CGA informed about the next work assignment(s) received by any CGA worker—saving the software thread blocks the overhead of keeping each other closely informed about dynamic work assignments. In some embodiments, the associated instruction, packet structure and behavior may be similar to what is described in PROGRAMMATICALLY CONTROLLED DATA MULTICASTING ACROSS MULTIPLE COMPUTE ENGINES, Publication No. US-20230289190A1 (Sep. 14, 2023).

On a processing core receiving a Packet workid_cga_broadcast_completion_ack from MPC, the processing core filters the packet based on part_id to ensure it was destined for this processing core. If yes, a CGA broadcast workid transaction is complete and the processing core uses WarpID on the packet to update corresponding transaction tracking counters.

Example handling through intermediary network circuit MPC

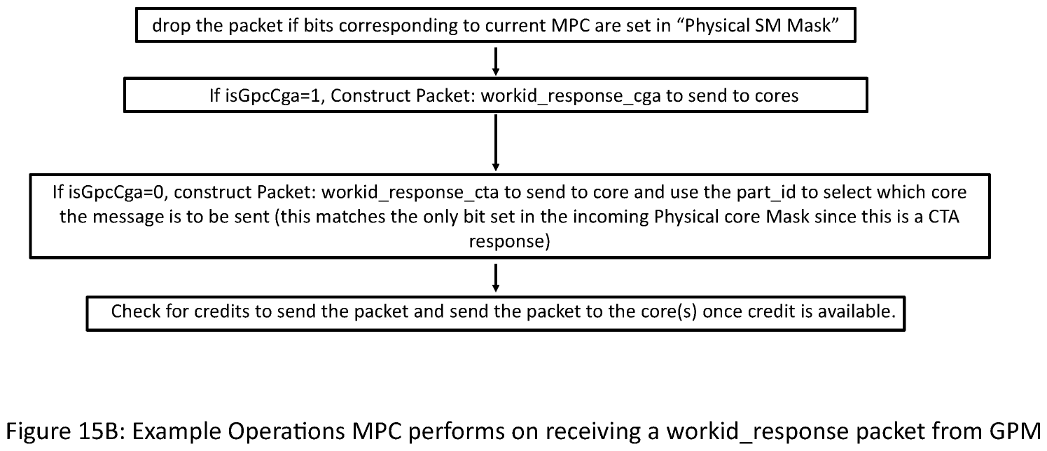

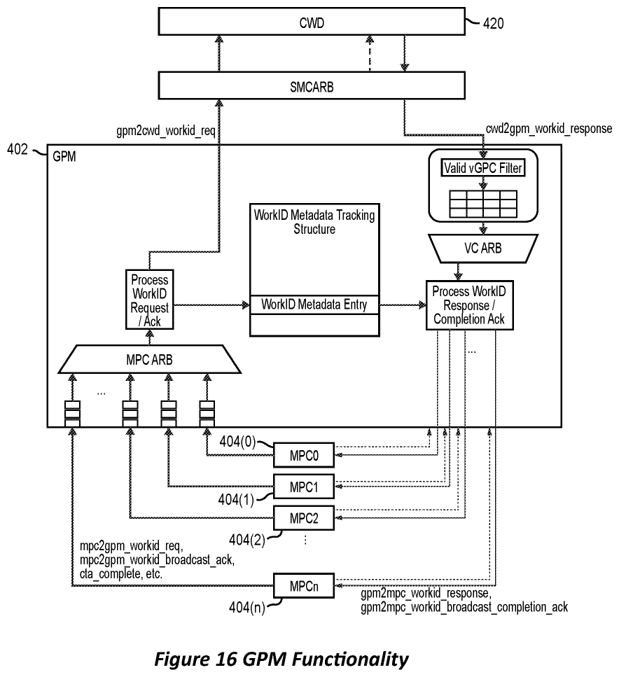

FIG. 15A shows example operations MPC may perform on receiving a workid_req packet from a processing core. MPC constructs a corresponding packet to send to GPM by appending certain fields which the MPC looks up based on WarpID.

FIG. 15B shows example operations MPC may perform on receiving a workid_response packet from GPM. MPC may selectively drop a packet, but otherwise constructs a workid_response packet to send to the core(s). Such constructed response packets may be broadcast to all cores/CTAs running CGA thread blocks or sent to just the core/CTA that originated the request, or may be multicast to selected multiple cores/CTAs.

### Example Handling Through Intermediary Network Circuit GPM

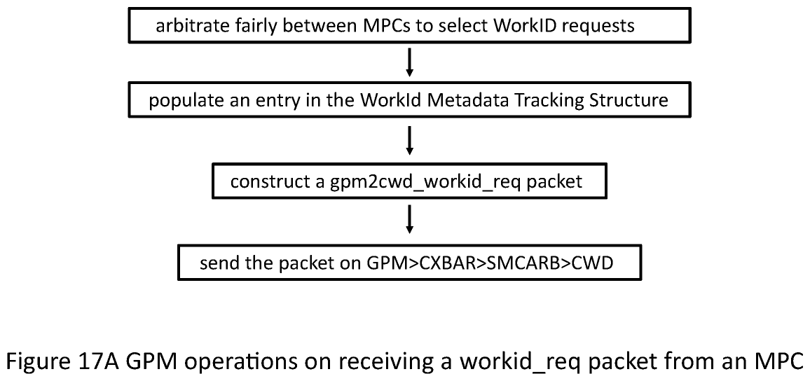

FIG. 16 shows example functionality and crediting performed by the GPM in example embodiments.

As shown in FIGS. 10 and 16, GPM sends work item responses to MPCs over a dedicated virtual channel. This provides an added benefit that GPM always guarantees it will accept a work item response for every request it has sent. Due to this, GPM doesn't need to expose a credit return interface for work item responses and SMCARB doesn't need to check/track them at all. In example embodiments, SMCARB always broadcasts all the packets to all the GPMs, and it is GPM's responsibility to only accept the packets for matching vGPC IDs and discard the rest

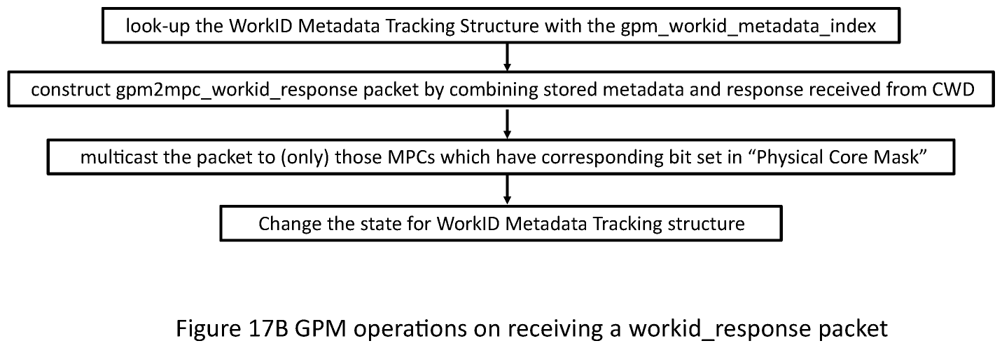

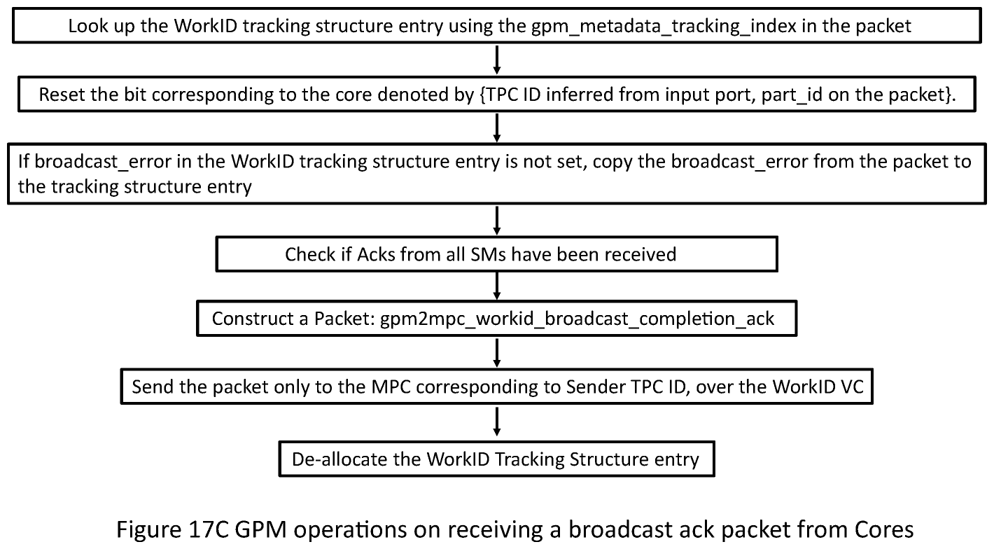

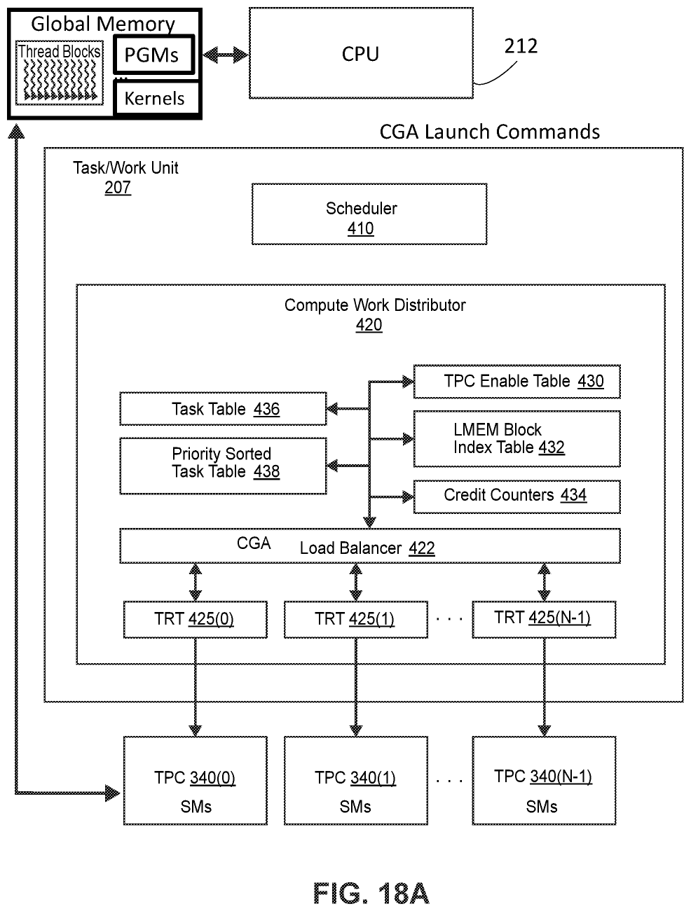

FIG. 17A shows example GPM operations on receiving a workid_response packet from an MPC, FIG. 17B shows example GPM operations on receiving a workid_response packet from CWD, and FIG. 17C shows example GPM operations on receiving a broadcast ack packet

In connection with these operations, GPM stores in a metadata tracking structure the following metadata needed by the requesting core along with the response, sized to the maximum number of workid requests per core (four in this example, but it could be sized to one or 2 requests per core for smaller chips, or more request per core for larger chips):

```
Struct: gpm_workid_metadata[numCORE*4]
  • valid
  • shared memory data address offset
  • shared memory barrier address offset
  • WarpID = {part_id, subpart_id, warp_id}
  • threadblock (CTA) ID
  • gpc_local_cga_id
  • Sender TPCID
  • isGpcCga
  • Physical core Mask
  • Tracking State
    ∘ 0 - Request Tracking
    ∘ 1 - Ack Tracking
  • isBroadcast
  • broadcast_error = {No-error, OOR, CTA_not_present}
```

In example embodiments, GPM retains this information instead of sending it to CWD in order to reduce the messaging bandwidth to CWD and associated complexity. GPM can then send a lightweight work item request message to CWD informing CWD only what it needs to know for load balancing and work assignment. See FIG. 17A.

When CWD responds to a work item request with a work item response, GPM accesses this stored information (see FIG. 17B) to construct a work response packet to be sent to the processing cores via appropriate MPCs.

For CGA broadcast requests, each core sends an Ack to GPM through MPC. On receiving a Packet: workid_cga_broadcast_ack from a core, MPC forwards the contents to GPM. As FIG. 17C shows, GPM continues to track broadcast acknowledgements from each core/CTA in a CGA. Once GPM receives a broadcast completion Ack from all cores/CTAs, it constructs and sends a Completion Ack to the leader core where the request began. On receiving a Packet: workid_broadcast_completion_ack from GPM, MPC forwards the contents as a Packet: workid_cga_broadcast_completion_ack to the core.

This feature adds the ability to request a new work item, but in example embodiments there is no structure/control over the returned work item. In another embodiment, this is extended to get a structured work item assignment i.e. along the same X or same Y or some other deterministic pattern of the 3D array of work items the workID designates, so the application can take advantage of this locality in the grid.

Additionally, in other example embodiments, persistent CTAs are supported with mixed CGA shapes.

### Example Use Cases & Systems

The techniques disclosed herein may be incorporated in any processor that may be used for processing compute or other tasks including but not limited to a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA GeForce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All patents and publications cited herein are expressly incorporated by reference for purposes of background and enablement but shall not be used or applied as a basis for disclaiming subject matter.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A computing method comprising:
launching at least one kernel on a processing core,
receiving a work assignment request from the at least one kernel, and
in response to the work assignment request, dynamically assigning a work item for the at least one kernel to perform without requiring relaunching of the at least one kernel.

2. The computing method of claim 1 further including the at least one kernel executing a programmatic instruction to generate the work assignment request.

3. The computing method of claim 1 wherein dynamically assigning comprises sending the at least one kernel a work identifier indexing into a three dimensional grid array.

4. The computing method of claim 1 wherein dynamically assigning includes broadcasting or multicasting a response to a plurality of kernels.

5. The computing method of claim 4 wherein dynamically assigning work items for the kernels to perform in response to the work assignment requests from the kernels load balances between the kernels.

6. The computing method of claim 1 wherein launching the at least one kernel includes giving the at least one kernel an initial work assignment to execute.

7. The computing method of claim 1 wherein launching the at least one kernel includes dynamically launching additional kernels to utilize any new processing cores that become available.

8. The computing method of claim 1 wherein the at least one kernel comprises at least one thread block.

9. The computing method of claim 1 wherein the at least one kernel comprises a CTA within a CGA.

10. The computing method of claim 1 wherein dynamically assigning includes assigning more than one work item for the at least one kernel to execute.

11. The computing method of claim 1 further including persistently executing the at least one kernel on the processing core.

12. The computing method of claim 1 further including specifying a total amount of work for persistent execution without explicitly specifying the number of kernels to be launched on processing cores, and automatically choosing an appropriate number of kernels to be launched on processing cores to support persistent execution of the total amount of work.

13. A graphics processing unit comprising:
a work distributor, and
a plurality of processing cores,
the work distributor being configured to launch a thread block to execute on at least one of the plurality of processing cores, receive a work assignment request from the executing thread block, and in response to the work assignment request, dynamically assign a work item for the thread block to execute without requiring relaunch of the executing thread block.

14. The graphics processing unit of claim 13 further including the at least one processing core executing a programmatic instruction within the thread block to generate the work assignment request.

15. The graphics processing unit of claim 13 wherein the work distributor is further configured to send the executing thread block a work identifier indexing into a three dimensional grid array.

16. The graphics processing unit of claim 13 wherein the work distributor is further configured to cause broadcast or multicast of a response to a plurality executing thread blocks on a respective plurality of processing cores.

17. The graphics processing unit of claim 16 wherein the work distributor is configured to selectively decline work assignment requests in order to load balance based at least in part on responses from the executing thread blocks.

18. The graphics processing unit of claim 13 wherein the work distributor gives the thread block an initial work assignment to execute at launch.

19. The graphics processing unit of claim 13 wherein the thread block comprises a CTA within a CGA.

20. The graphics processing unit of claim 13 wherein the work distributor is further configured to assign more than one work item to the thread block to execute.

21. The graphics processing unit of claim 13 wherein the processing core persistently executes the thread block.

22. The graphics processing unit of claim 13 wherein an application specifies a total amount of work for persistent execution without explicitly specifying the number of thread blocks to be launched on processing cores, and the work distributor automatically chooses an appropriate number of thread blocks to launch on the processing cores to support persistent execution of the total amount of work.

23. The graphics processing unit of claim 13 wherein the work distributor dynamically launches additional thread blocks to utilize any new processing cores that become available.

24. A nontransitory memory configured to store data including at least one instruction that when executed causes at least one processing core to generate and send a work item request message to a compute work distributor, the instruction comprising:
an opcode indicating a work item request generation,
a first field indicating whether a work item response should be broadcast or not,
a second field indicating a shared memory address where work item response data should be written, and
a barrier address specifying a shared memory address of a synchronization barrier to use in connection with the work item request.

25. A work distributor comprising:
a data receiver that receives a specification of work to do;
a selector that selects a variable number of workers based on available processing resources; and
a scheduler that handshakes with the executing workers to assign more work as previously assigned work is completed and/or more processing resources become available, to provide persistent kernel functionality.

26. The work distributor of claim 25 wherein the scheduler selectively declines work assignment requests for reasons including load balancing and prioritization.
